(19) United States
(12) Patent Application Publication
(10) Pub. No.: US 2005/0252330 A1
(43) Pub. Date: Nov. 17, 2005

(54) Switch apparatus

(75) Inventor: Peter Denk, Freiburg (DE)

Correspondence Address: JORDAN AND HAMBURG LLP, 122 EAST 42ND STREET, SUITE 4000, NEW YORK, NY, 10168, US

(73) Assignee: Denk Engineering GmbH, Freiburg (DE)

(21) Appl. No.: 10/844,623

(22) Filed: May 13, 2004

(51) Int. Cl. B62L 3/00

(52) U.S. Cl. 74/502.2; 188/2 D; 188/24.22; 188/299.1; 74/501.6

(57) ABSTRACT

A switch apparatus (5) for adjusting the compression and/or damping properties of a shock absorber (2) has an operating element (8) that is actuatingly linked to the shock absorber (2) and has at least one control device (6) that is connected to the adjusting elements of the at least one shock absorber (2) to be adjusted. Allocated to the at least one control device (6) is a single, common operating element (8) for selectively or reciprocally adjusting both the compression and the damping properties of the shock absorber or shock absorbers (2). The actuating links between control device (6) and shock absorber (2) and between control device (6) and operating element (8) are each formed by one or a plurality of Bowden cables (7a, 7b) or by one or a plurality of hydraulic or pneumatic line(s) or a mechanism.

The invention relates to a switch apparatus for adjusting the compression and/or damping properties of a shock absorber with an operating element that is actuatingly linked to the shock absorber and with at least one control device that is connected to the adjusting elements of the at least one shock absorber to be adjusted.

The compression and/or damping properties of a shock absorber can generally be adjusted using adjusting elements, e.g., set screws, whereby one adjusting element each can be provided for the pull stage, pressure stage, and, if necessary, the range of spring. Frequently an additional adjusting element is also provided for adjusting the so-called lock-out, in which the oil flow for the shock absorber is largely blocked and high damping occurs such that it can practically no longer compress. The type of adjusting elements and their operation are generally different for different types of shock absorbers, so that the user must familiarize himself with the particular adjusting options before it is possible to modify the compression and/or damping properties. In particular, the relationship between compression and damping properties is very complex. For instance, for adjusting the lock-out, in which the range of spring is largely reduced to zero, it is not the compression behavior that must be modified, but rather damping must be set to a maximum value. That is, the rider must modify the damping in order to modify the range of spring to a minimum range of spring. These seemingly contradictory technical relationships are generally not familiar to the average bicyclist.

In addition, these adjustments can only be undertaken directly at the shock absorber, so that it is not possible to modify the shock absorber properties while riding the bicycle, for instance. Although there are already systems in which a lock-out can be turned on or off using the damping via an operating element that can be arranged for instance on the handlebar of a bicycle, in these systems it is not possible to affect the range of spring. Other systems have an operating element for modifying compression properties. However, in these systems it is not possible to affect the damping behavior or the adjustment of a lock-out.

Known from DE 199 22 745 A1 is a wheel suspension apparatus for motorcycles that has an electronic control device for adjusting the damping force and/or the compression force of at least one suspension unit between wheel and motorcycle frame. The suspension unit itself has an electromechanical setting apparatus that is actuated by means of the electronic control device. An energy supply, for instance a battery, which requires additional space and has weight, is required for the electronic control device and for the electromechanical setting apparatus. However, such an electronic adjusting option for damping and/or compression properties is susceptible to malfunction and can only be actuated when the energy supply is intact. If the energy supply fails, for instance if the battery has discharged, it is not possible to modify the shock absorber properties. The energy supply has a negative effect, especially when using the switch apparatus on a bicycle, because both component size and weight are critical factors in bicycle construction.

The object is therefore in particular to create a switch apparatus of the type cited in the foregoing with which both the compression and the damping properties of shock absorbers can be modified simply, without special knowledge about the particular shock absorber and the technical aspects of compression and damping behavior, even during operation of the shock absorber, for instance while riding the bicycle. In addition the switch apparatus should operate reliably and with certitude and should have a limited size and limited weight.

The inventive solution for this object is comprised in particular in that allocated to the at least one control device is a single, common operating element for selectively or reciprocally adjusting both the compression and the damping properties of the shock absorber or shock absorbers and in that the actuating links between control device and shock absorber and between control device and operating element are each formed by one or a plurality of Bowden cables or by one or a plurality of hydraulic or pneumatic line(s) or a mechanism.

Thus, the user can modify all adjustable shock absorber properties by actuating only the one operating element. Since the actual control of the shock absorber, that is, its individual adjusting elements, is performed using the control device, the user does not require any special knowledge about the shock absorber being used. The operating element can for instance have three switch positions for soft compression behavior, for hard compression behavior, and for a lock-out position in which the shock absorber is practically blocked or has such a hard ride that it approximates blocking.

In this manner, one single shock absorber can be controlled with the one operating element. However, it is also possible to jointly control a plurality of shock absorbers with the one operating element. It is advantageous that the user only has to operate one single operating element for controlling a plurality of shock absorbers, which simplifies operation considerably, since the user can concentrate on this one operating element.

The actuating link(s) between control device and shock absorber or between control device and operating element can each be formed using one or a plurality of Bowden cables, which enables a simple mechanical design for the switch apparatus. It is also possible to provide the actuating link using a mechanism, which can be formed for instance by rods.

Alternatively, depending on the type of shock absorber to be controlled, the actuating link(s) between control device and shock absorber or between control device and operating element are each formed by one or a plurality of hydraulic or pneumatic line(s).

One embodiment of the inventive switch apparatus is comprised in that one control device, preferably arranged in the region of the shock absorber, is allocated to each shock absorber to be controlled, and in that the control devices are each actuatingly linked to the operating element.

Another embodiment provides that a common control device is provided that is preferably arranged in the region of the operating element, and that the control device has one actuating link for each of the adjusting elements of the shock absorber(s) to be controlled. This can be particularly useful when there is not much space available for the shock absorbers in the mounting area.

The operating element can be a thumb switch, for instance. This enables particularly simple operation using just one finger.

However, the operating element can also be a twist grip that is actuated like the accelerator grip for a motorcycle or like a conventional twist grip gearshift on a bicycle.

The inventive switch apparatus can be used for different apparatus and fields of employment. One preferred application is use on a bicycle in order to be able to adjust both the rear wheel compression/damping and the front wheel compression/damping.

In order to enable actuation while riding, it is useful when the operating element can be arranged on a bicycle handlebar, the forward structure, or some other easily accessible part of a bicycle.

It can be useful when the operating element and/or the control device is integrated into the shifting apparatus of a gearshift or when it is a component of the shifting apparatus. In this way the switch apparatus can be arranged in a particularly simple and space-saving manner for instance on a bicycle handlebar. Joint usage of individual elements for both the gearshift and for the inventive switch apparatus can save weight and costs.

It should be mentioned that the term “shock absorber” should not be construed as just a shock absorber in the narrow technical sense. What is meant is not just for instance shock absorbers as they are employed for rear-wheel suspension of a bicycle, but for instance and in particular also in shock absorbers integrated in spring forks or telescoping spring forks for suspension of the front wheel on a bicycle. Likewise, the definition of terms is not limited to pure damping elements, but also includes elements with combined damping and compression behavior.

The term “range of spring” herein does not describe only the absolute spring length. It can also refer to the useable range of spring that is adjustable using a harder or softer spring rate.

Exemplary embodiments of the inventive switch apparatus are explained in greater detail in the following using the drawings.

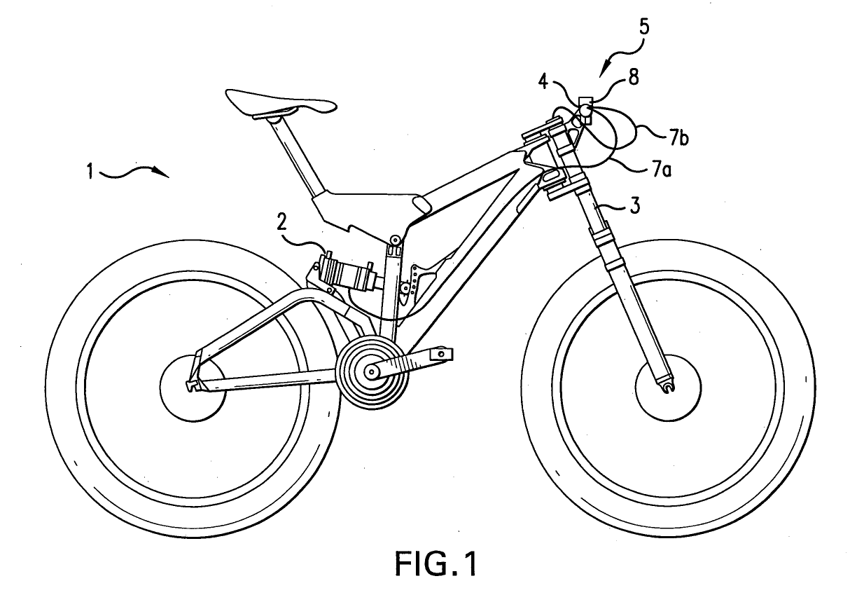

FIG. 1 illustrates a bicycle with a switch apparatus for a rear wheel shock absorber and a front wheel shock absorber;

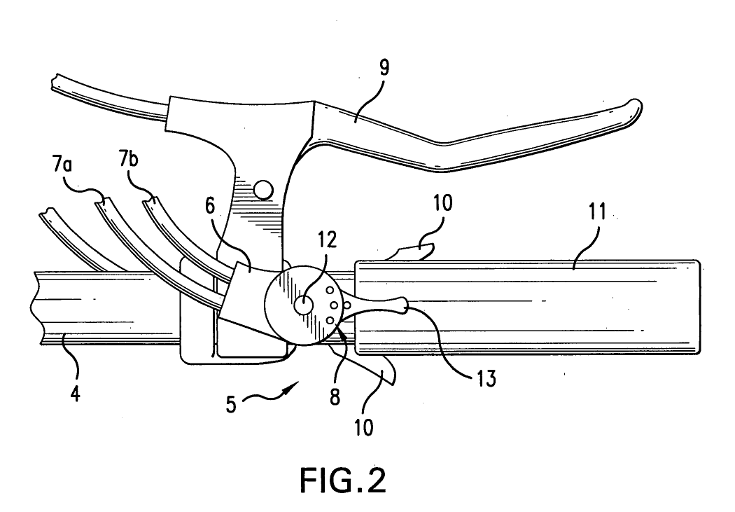

FIG. 2 and

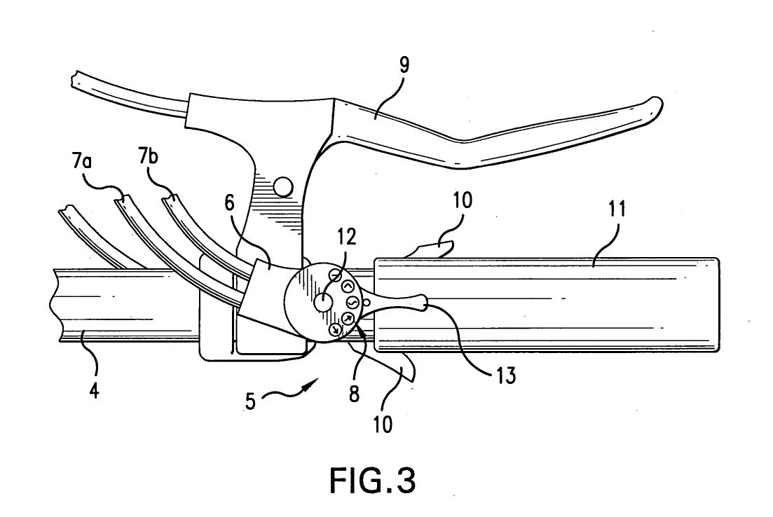

FIG. 3 each illustrate a bicycle handlebar with a switch apparatus in which the operating element is a thumb switch; and,

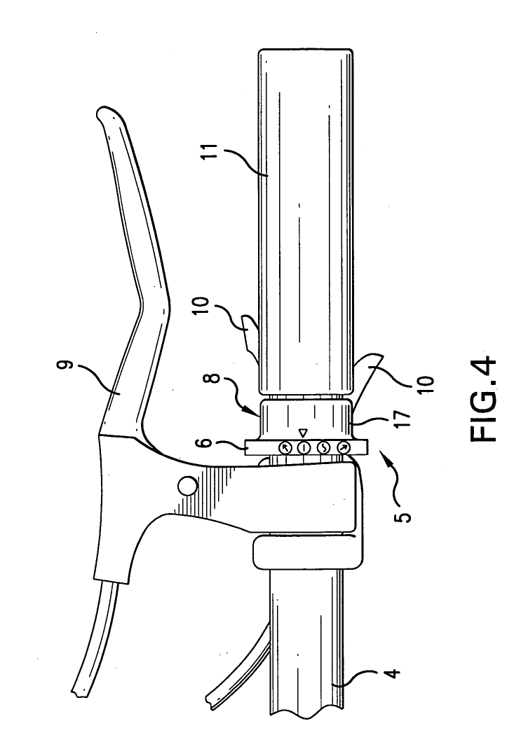

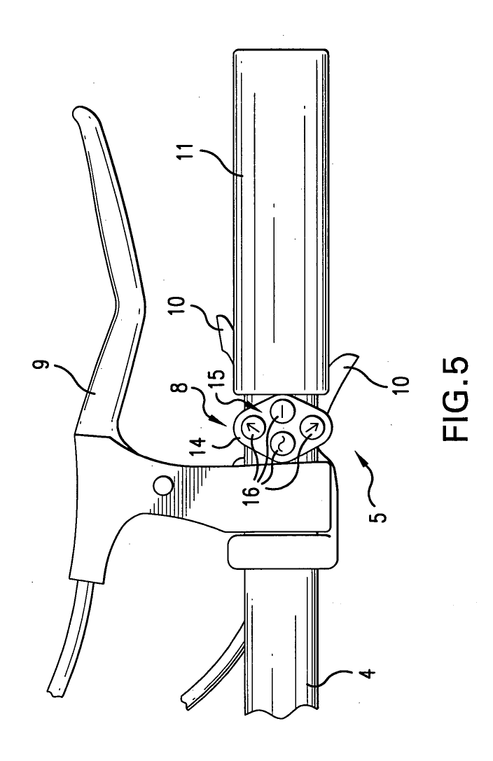

FIG. 4 illustrates a bicycle handlebar with a switch apparatus in which the operating element is a twist grip.

FIG. 1 illustrates a bicycle 1 with a rear wheel shock absorber 2 and a front wheel shock absorber (not shown in greater detail) that is integrated in a spring fork 3. Affixed to the handlebar 4 of the bicycle 1 is a switch apparatus 5 for adjusting the compression and damping properties of the shock absorbers. The switch apparatus 5 has a control device (not illustrated in greater detail in FIG. 1) that is connected to adjusting elements of the shock absorbers via Bowden cables 7a, 7b. A single, common operating element 8 for selectively or reciprocally adjusting the compression and the damping properties of the shock absorbers is allocated to the control device.

A bicycle rider can modify the damping and/or compression behavior of the shock absorbers while riding the bicycle and without specialized knowledge about the shock absorbers by actuating the operating element 8. Both shock absorbers can be jointly adjusted with the one operating element 8, so that the operation of the switch apparatus 5 is very simple.

FIG. 2 illustrates the outer edge region of a bicycle handlebar 4 with a brake lever 9 and a gearshift lever 10 for shifting gears. An operating element 8 that is designed as a thumb switch and that is for the inventive switch apparatus 5 is arranged in the region of the handlebar grip 11. The operating element 8 has an exterior adjusting lever 13 that pivots about an axis of rotation 12. In the illustrated exemplary embodiment, the operating element 8 has three possible switch positions, each of which is indicated by a dot. When the operating element 8 is actuated, the rotational movement of the adjusting lever 13 is converted in the downstream control device 6 into a pulling motion for the Bowden cables 7a, 7b that are connected to the adjusting elements of the shock absorbers. For instance, the first switch lever position causes soft compression on both shock absorbers, the illustrated center switch lever position effects a harder compression, and the third switch lever position puts both shock absorbers into a lock-out condition in which they are practically blocked. Thus the riding behavior of the bicycle can be adapted to the current conditions with a single hand motion.

It is also possible that the switch apparatus 5 is provided for controlling only one shock absorber. In this case, both of the Bowden cables 7a, 7b illustrated in FIG. 1 are connected to the one shock absorber. For instance, one Bowden cable 7a can be connected to one adjusting element for the range of spring displacement and the second Bowden cable 7b can be connected to one adjusting element for the damping adjustment or a lock-out function.

Depending on the type and number of the shock absorbers to be controlled, it is also possible to provide more than the two illustrated Bowden cables 7a, 7b as actuating link between the control device 6 and the shock absorbers.

Hydraulic or pneumatic lines can also be provided as actuating link instead of the Bowden cables 7a, 7b. The type of the actuating link used in particular depends on the type of shock absorbers to be controlled and their adjusting elements. In some cases, space and weight considerations can also be determining factors for a certain type of actuating link.

FIG. 3 illustrates a switch apparatus 5 with an operating element 8 that has been expanded compared to FIG. 2. In this case, a total of five switch conditions (each indicated by a symbol) can be set with the adjusting lever 13. The symbols make it possible for the user to visualize the situation for which a certain setting is appropriate. The symbols can symbolize for instance “upward incline”, “downward incline”, “uneven terrain”, “flat terrain”, and so forth. By selecting the corresponding adjusting lever position, the shock absorbers are set to a compression and damping behavior that is best suited for the current terrain. For instance, when riding on an upward incline, a lock-out can be set in order to prevent “bottoming out” when pedaling out of the saddle. On uneven terrain, soft compression is set in order to cushion jolts that affect the wheels. Thus, the rider does not have to know the physical background in terms of which compression behavior should reasonably be combined with which damping behavior for which external features; rather, the shock absorbers can be adapted to the current situation based on the symbols.

FIG. 4 illustrates a switch apparatus 5 with an operating element 8 embodied as a twist grip. It can be designed such that the entire handlebar grip 11 is rotated, preferably after unlocking a twist lock (not illustrated), in order to change to another switch position. In this embodiment, however, the exterior part 17 of the operating element 8 is preferably borne sleeve-like and rotatable on the handlebar 4 so that only this exterior part 17 has to be rotated in order to change the switch condition.

The inventive switch apparatus can be employed not only for the preferred application on a bicycle illustrated here. Other areas of usage are also conceivable in which one or a plurality of shock absorbers frequently must be switched into different operating modes. Possible areas of usage are for instance street bikes with adjustable shock absorber properties for different types of routes such as country roads, highways, or speedways. Another area of usage is Enduro motorcycles with adjustable shock absorber properties for light terrain, severe terrain, motocross terrain, special Enduro testing, etc.

Similarly, the area of usage is not limited to systems with one or two shock absorbers. Theoretically any desired number of shock absorbers can be operated with the inventive switch apparatus.

1-8. (canceled)

9. Apparatus for adjusting compression and/or damping properties of at least one shock absorber having at least one adjusting element, comprising a control device, a single, common operating element operatively connected to the control device for selectively or reciprocally adjusting both compression and damping properties of said at least one shock absorber, and at least one actuating linkage connected to the control device for operatively connecting the control device to said at least one adjusting element.

10. Apparatus according to claim 9, for a plurality of shock absorbers, comprising a plurality of control devices each for operative connection to a respective said adjusting element of a respective one of said shock absorbers, said single, common operating element being operatively connected to said control devices.

11. Apparatus according to claim 9, wherein the at least one linkage comprises at least one Bowden cable.

12. Apparatus according to claim 9, wherein the at least one linkage comprises at least one hydraulic line.

13. Apparatus according to claim 9, wherein the at least one linkage comprises at least one pneumatic line.

14. Apparatus according to claim 9 for at least one shock absorber having a plurality of adjusting elements, comprising respective said linkages for operatively connecting the control device to each of said adjusting elements.

15. Apparatus according to claim 9, wherein the operating element comprises a thumb switch.

16. Apparatus according to claim 9, wherein the operating element comprises a twist grip.

17. Apparatus according to claim 9, wherein the operating element comprises at least one press button.

18. Apparatus according to claim 9, wherein the operating element is mountable on a bicycle handlebar.

19. Apparatus according to claim 9, wherein the operating element is mountable on a bicycle handlebar fork.

20. Apparatus according to claim 9, wherein the operating element is mountable on a bicycle frame.

21. A combination comprising a gearshift shifting apparatus and an apparatus according to claim 9, wherein at least one of said operating element and said control device is integrated into said shifting apparatus.

22. A combination comprising a gearshift shifting apparatus and an apparatus according to claim 21, wherein said shifting apparatus comprises at least one of said operating element and said control device.
